(19) United States
(12) Patent Application Publication
(10) Pub. No.: US 2011/0231818 A1
(43) Pub. Date: Sep. 22, 2011

(54) Method and device for operating software-controlled devices

(75) Inventor: Ulf STEDEN, GLINDE (DE)

(73) Assignee: SAFEBRIDGE UG, Hamburg (DE)

(21) Appl. No.: 12/852,881

(22) Filed: Aug. 9, 2010

(30) Foreign Application Priority Data
Mar. 18, 2010 (DE) 10 2010 011 873.7

(51) Int. Cl. G06F 9/44

(52) U.S. Cl. 717/120

(57) ABSTRACT

The method and the device serve for operating software-controlled devices. At least a portion of software for controlling at least two different devices is stored in the area of a data storage. The software is activatable such that, after a selection of a concrete device, the control software required for this device is made available for the user and an operation of the device becomes possible.

The invention relates to a method for operating software-controlled devices.

The invention relates, moreover, to a device for operating software-controlled devices.

The predominant number of electrical and electronic devices which are in use are equipped with software which facilitates the control and operation of the devices. For service technicians who maintain and/or repair such devices, and in connection with training for operating such devices, the problem occurs that the individual devices are equipped with very different controls and operating surfaces. It has therefore been found very difficult if a service technician or a not specifically trained operating person is supposed to carry out for the first time repairs, maintenance sequences or operating sequences on a device which the respective person is not yet familiar with.

In the following, the respective operating problems as well as the solution according to the invention for these problems will be described in connection with the example of radar devices which are used in the maritime field. This description in connection with an example can also be transferred to the operation of all other software-controlled devices without this being mentioned expressly in each individual case.

It is the object of the present invention to improve a method of the above-described type in such a way that a user is supported by receiving an increased familiarity with the operation of software-controlled devices.

In accordance with the invention, this object is met by storing at least a portion of software for controlling at least two different devices in the field of at least one data storage unit and making the software activatable in such a way that it becomes possible for the user, after a selection of a concrete device, that the control software required for this device is available and to operate the device.

Another object of the present invention is to construct a device of the above-stated type in such a way that an operation of software-controlled devices is facilitated.

In accordance with the invention, this object is met by storing at least a portion of software for controlling at least two different devices in the area of at least one data storage unit, and to construct an activation for the software in such a way that, after a selection of a concrete device, the control software assigned to this device is activatable.

By making available specific software for different devices, it is possible to make available with few configuration sequences the software required for operating a specific device. A service technician who is working to repair or maintain a specific device, can now access a collection of software, he can activate the actually required software, and he can allow the device to be maintained automatically to assume the desired state of operation. Also, it is possible already prior to a direct contact with the actual device, to activate the corresponding software and to train in cooperation with an actually existing device or a simulated device the operation of the respective device. As a result, it is provided that in the event of a contact with the actual device, the required operations can be carried out without significant time delay.

A typical application takes place in connection with control software for radar devices. The radar devices can be used, for example, for maritime applications, in airplanes, in the field of flight security, or in military fields.

A use at any desired location is reinforced by the fact that a storage of the individual control software of the device takes place in a spatial vicinity to a visual display and a manual input device for the user.

A universal data access is supported by the fact that a storage of the individual software for controlling the concrete device takes place at a faraway location to a user and a transmission through a data connection is carried out.

With respect to applications in connection with service and repair, it is intended that the control software cooperates with a device which is present as hardware.

When applied for training, it is found to be useful that the software cooperates with a software module which simulates the actual device.

Also, in connection with schooling or an operating training, it is being considered in particular that with the use of an interactive plane, a device operation takes place as a remote control. Typically, a remote control takes place in such a way that an access to the original software of the device to be controlled is provided.

In the drawings, embodiments of the invention are schematically illustrated. In the drawing:

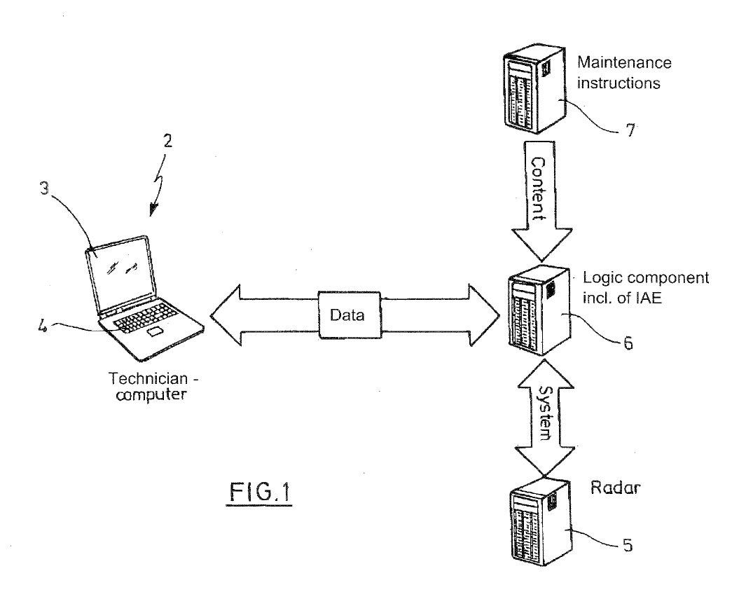

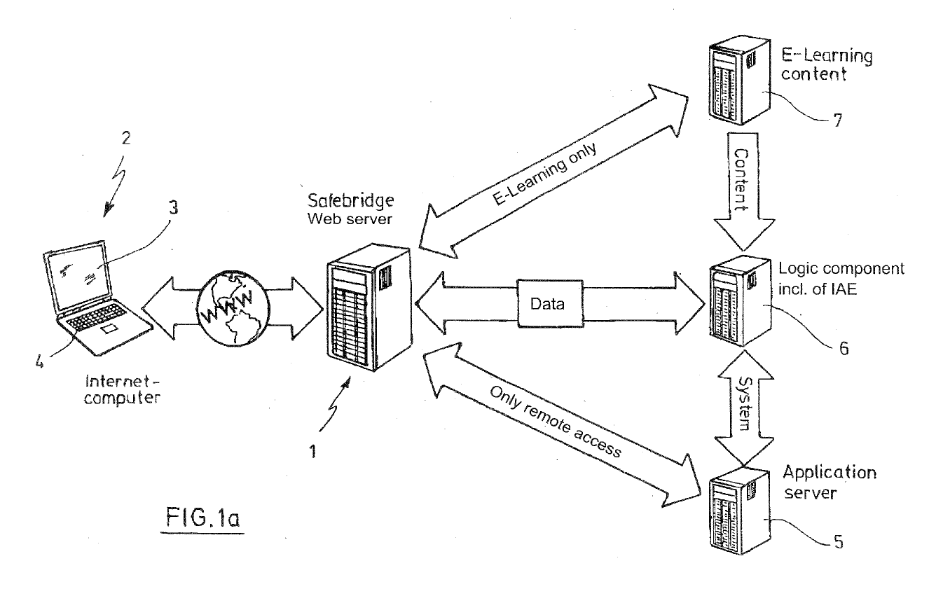

FIG. 1 is a device-technological overview illustration for use in the service field;

FIG. 1a is a device-technological overview illustration for use in the training field;

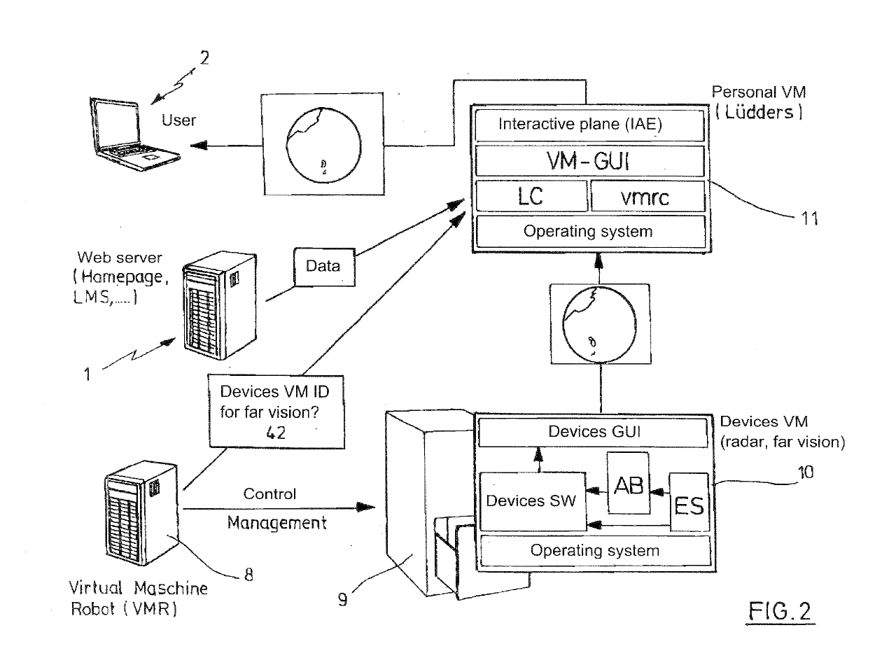

FIG. 2 is a simplified functional representation for illustrating the interaction of the individual function components; and

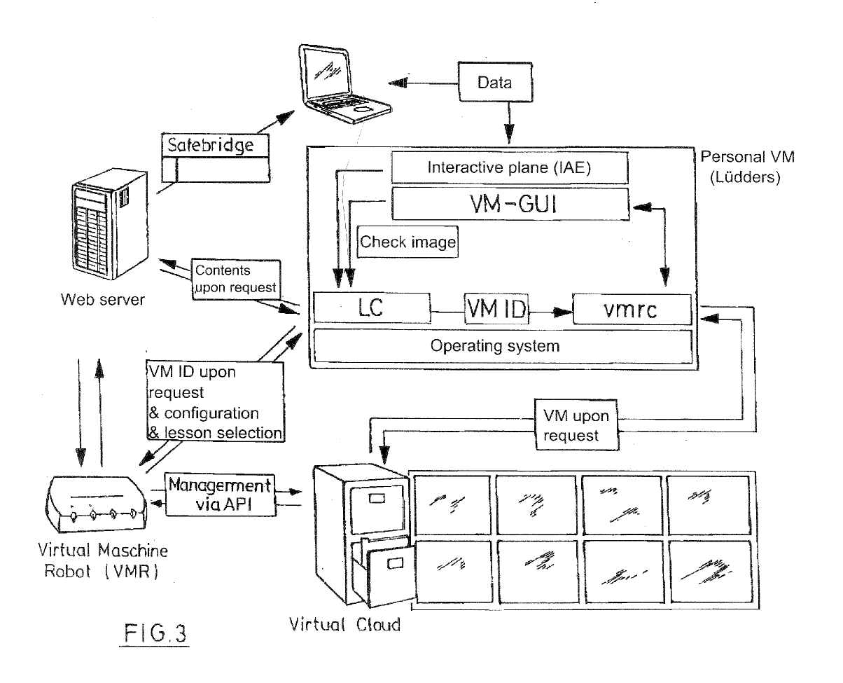

FIG. 3 is a representation similar to FIG. 2 for a modified embodiment.

FIG. 1 illustrates an embodiment for service applications. In this connection it is provided that a service technician with an operating computer 2 travels to the intended location of application. The operating computer 2 includes a display 3 and an operating device 4. The operating computer 2 is connected to a radar device 5 with the intermediate arrangement of a logic component 6. With the use of a contents storage unit 7, for example, maintenance instructions are generated.

It is particularly intended to make available to the service technician at least two different functionalities. In accordance with a first functionality, it is possible with the use of the operating surface to transfer the radar device 5 automatically into a defined state in order to be able to carry out predetermined maintenance or service work. The defined state may comprise, for example, a set of parameters which reproduces one or more sets of measured values of the radar device 5.

In accordance with a second functionality, it is possible to generate, in the area of the operating computer with the use of the maintenance instructions 7, defined service instructions which make it possible for the service technician to carry out a targeted operation of the radar device 5 without the service technician having to be familiar with all the functionalities of the radar device 5. In accordance with a preferred embodiment, the service technician receives in the area of the display 3 of his operating computer 2 a display which corresponds to the actual displays of the radar device 5.

In the following, a second embodiment for applications in connection with conducting training or education is explained.

In accordance with the embodiment illustrated in FIG. 1a, in the area of a storage device 1 a plurality of software is made available for controlling devices. The respective software can be stored physically either entirely or partially in the area of the storage device 1, wherein, in accordance with the illustrated embodiment, a web server is used as the connecting element to the storage device 1 which makes possible any selected local storage and access through the internet. The storage device 1 is connected to an operating computer 2 which preferably has at least one display 3 and an operating device 4.

The storage device 1 is coupled to an application server 5, a logic component 6 and a contents storage 7. The application server 5 is additionally directly coupled to the logic component 6. Also provided is a direct coupling between the logic component 6 and the contents storage 7.

FIG. 2 shows a functional switching diagram for illustrating a utilization of the functional components for training of a device operation for a user. From a control device 8, which in FIG. 2 is designated as a virtual machine robot VMR, a triggering or sequence control for the required processes is carried out. The control device 8 selects the concretely required software in dependence on the concretely desired technical device from a supply storage 9. The selection takes place with the use of a virtual machine identification VMID. The supply storage 9 is preferably equipped with its own operating system. The supply storage 9 includes, for example, the control software required for different radar devices and/or device simulation software which is also referred to as devices VM (Virtual Machine). In the area of the supply storage 9, a simulator 10 is additionally provided for simulating real data. The simulator 10 is also called environment simulator (ES). Moreover, an analogous component (AB) can be used which is implemented physically or as a simulation module. Ranked above is a device GUI (Graphic User Interface).

In the area of the web server, a home page or a learning management system (LMS) may be made available.

Based on the data in the supply storage 9, a concretely required software module 11 is made available for the individual user, wherein the software module includes the, the corresponding operating system, a control unit (LC, logic controller), a communication program (VMRC, virtual machine remote console), as well as an interactive plane (IAE).

During a use by the user, displays are generated on the operating computer 2 within the scope of the operating training, wherein the displays correspond to displays of the actual device. The user can carry out operating inputs through the interactive plane which, due to the imitation of the actual device, generate reactions on the display which correspond to an actual sequence. As a result of the concept according to the invention, several operating layers are placed on top of each other.

FIG. 3 shows a more complex function sequence in connection with a realization of the invention for an operating practice. Also in this case, the explanation using an example takes place on the basis of concrete radar devices which are to be simulated.

The interactive plane in a simplified manner carries out the function of a mask provided with holes. The contents made available by the logic controller are displayed in the movable windows and operating activities of the user in the movable windows are reported back to the logic controller. Also user inputs are forwarded to the logic controller by using a mouse or a keyboard of the operating computer 2. Because of the simulation software which has been made available, the corresponding inputs lead exactly to the same reactions as if the operation had been carried out on the actual devices.

1-10. (canceled)

11. A method for operating software-controlled devices, comprising the steps of: storing at least a portion of software for controlling at least two different devices in an area of at least one data storage; and selecting a concrete device whereby the control software required for the selected device is made available to a user and an operation of the device is made possible.

12. The method according to claim 11, including storing the individual control software of the device in spatial vicinity of a visual display and a manual input device for the user.

13. The method according to claim 11, including storing the individual software for controlling the concrete device remotely relative to the user, and transferring data through a data connection.

14. The method according to claim 11, wherein the control software interacts with a hardware device.

15. The method according to claim 11, wherein the control software interacts with a software module that simulates the concrete device.

16. The method according to claim 11, including simulating device operation using an interactive plane.

17. A device for operating software controlled devices, comprising a data storage, at least a portion of the software for controlling at least two different devices being stored in an area of the data storage so that when a concrete device is selected the control software assigned to the device is activatable.

18. The device according to claim 17, wherein the data storage is arranged in spatial vicinity to an operating computer.

19. The device according to claim 17, wherein the data storage arranged remote from an operating computer, the data storage and the operating computer being connectible to each other through a data network.

20. The device according to claim 17, wherein the concrete device is reproduced in accordance with a software module.
